(19) United States
(12) Patent Application Publication
(10) Pub. No.: US 2026/0243677 A1
(43) Pub. Date: Aug. 20, 2026

(54) ODOR IDENTIFICATION SYSTEM AND GAS SENSOR

(71) Applicant: PANASONIC HOUSING SOLUTIONS CO., LTD., Osaka (JP)

(72) Inventors: Toshihiro SAKAMOTO, Osaka (JP); Yoshitsugu URIU, Osaka (JP); Atsuo NAKAO, Nara (JP); Hiroshi USHIO, Osaka (JP); Yoshiki YAMADA, Osaka (JP)

(21) Appl. No.: 19/153,884

(22) PCT Filed: Feb. 2, 2024
(86) PCT No.: PCT/JP2024/003584

§ 371 Date: Aug. 5, 2025

(30) Foreign Application Priority Data
Feb. 27, 2023 (JP) 2023-027873

(51) Int. Cl. G01N 21/45

(52) U.S. Cl. CPC G01N 21/45

(57) ABSTRACT

An odor identification system includes a substrate having a principal surface in which a fine uneven structure is formed to exhibit a structural color; a polymer thin film disposed to cover the principal surface of the substrate, the polymer thin film having a light transmissive property and being capable of adsorbing an odor molecule included in the sample gas; and a detector that detects light transmitted through the polymer thin film, reflected by the fine uneven structure of the substrate, and exiting the polymer thin film.

### TECHNICAL FIELD

The present disclosure relates to an odor identification system and a gas sensor.

### BACKGROUND ART

There is known a system that determines whether a specific chemical substance is present in a sample gas (see, for example, Patent Literature (PTL 1). This system uses a gas sensor that includes a substrate, a waveguide thin film disposed so as to cover the principal surface of the substrate, and a first prism coupler and a second prism coupler each disposed in contact with the surface of the waveguide thin film.

Light from a light source is transmitted through the first prism coupler, the waveguide thin film, and the second prism coupler in this order, exits the second prism coupler, and is received by a detector. By measuring a change in the intensity of the light received by the detector, the system determines whether a specific chemical substance is present in a sample gas.

### CITATION LIST

### Patent Literature

### [PTL 1]

Japanese Patent No. 3,157,952

### SUMMARY OF INVENTION

### Technical Problem

The gas sensor of the conventional system described above, however, requires relatively large first prism coupler and second prism coupler, and this raises the problem that it is hard to reduce the size of the gas sensor or to manufacture a more highly integrated gas sensor.

Accordingly, the present disclosure provides an odor identification system and a gas sensor that are smaller in size and more highly integrated.

### Solution to Problem

An odor identification system according to one aspect of the present disclosure is an odor identification system that identifies an odor of a sample gas, and the odor identification system includes: a substrate including a principal surface in which a fine uneven structure is formed to exhibit a structural color; a polymer thin film disposed to cover the principal surface of the substrate, the polymer thin film having a light transmissive property and being capable of adsorbing an odor molecule included in the sample gas; and a detector that detects light transmitted through the polymer thin film, reflected by the fine uneven structure of the substrate, and exiting the polymer thin film.

Meanwhile, a gas sensor according to one aspect of the present disclosure is a gas sensor to be used in an odor identification system that identifies an odor of a sample gas, and the gas sensor includes: a substrate including a principal surface in which a fine uneven structure is formed to exhibit a structural color; and a polymer thin film disposed to cover the principal surface of the substrate, the polymer thin film having a light transmissive property and being capable of adsorbing an odor molecule included in the sample gas.

It is to be noted that general or specific aspects of the above may be implemented in the form of a system, a method, an integrated circuit, a computer program, or a computer readable recording medium, such as a compact disc-read only memory (CD-ROM), or through any desired combinations of a system, a method, an integrated circuit, a computer program, and a recording medium.

### Advantageous Effects of Invention

The odor identification system and so forth according to one aspect of the present disclosure makes it possible to manufacture an odor identification system and so forth that are smaller in size and more highly integrated.

### BRIEF DESCRIPTION OF DRAWINGS

FIG. 1 is a block diagram showing a configuration of an odor identification system according to Embodiment 1.

FIG. 2 is a plan view showing a gas sensor of the odor identification system according to Embodiment 1.

FIG. 3 is a schematic sectional view of the gas sensor of the odor identification system according to Embodiment 1, taken along the III-III line indicated in FIG. 2.

FIG. 4 is a flowchart showing a flow of an operation of the odor identification system according to Embodiment 1.

FIG. 5 presents photographs showing a result of an experiment in which a gas sensor is exposed to isopropyl alcohol.

FIG. 6 is a diagram showing a configuration of an odor identification system according to Embodiment 2.

### DESCRIPTION OF EMBODIMENTS

### Technique 1

An odor identification system that identifies an odor of a sample gas, the odor identification system including a substrate including a principal surface in which a fine uneven structure is formed to exhibit a structural color; a polymer thin film disposed to cover the principal surface of the substrate, the polymer thin film having a light transmissive property and being capable of adsorbing an odor molecule included in the sample gas; and a detector that detects light transmitted through the polymer thin film, reflected by the fine uneven structure of the substrate, and exiting the polymer thin film.

According to Technique 1, the gas sensor can be constructed by disposing the polymer thin film on the principal surface of the substrate in which the fine uneven structure is formed. This configuration renders the prism couplers described in the section titled Background Art above unnecessary and makes it possible to produce a smaller and more highly integrated gas sensor.

### Technique 2

The odor identification system according to Technique 1, wherein the light is white light, and the detector detects the structural color exhibited as the light reflected by a surface of the polymer thin film interferes with the light transmitted through the polymer thin film, reflected by the fine uneven structure of the substrate, and exiting the polymer thin film.

According to Technique 2, the characteristics of the polymer thin film change as an odor molecule included in the sample gas becomes adsorbed onto the polymer thin film, and the structural color exhibited by the fine uneven structure changes. This configuration makes it possible to identify the odor of the sample gas with ease based on the change in the structural color detected by the detector.

### Technique 3

The odor identification system according to Technique 2, wherein the white light has a wavelength range of from 400 nm to 900 nm.

According to Technique 3, when the detector is constituted, for example but not limited to, by an image sensor, the structural color can be detected reliably by the detector. Furthermore, Technique 3 enables the use of, for example but not limited to, a mercury lamp, which is inexpensive and has a broad wavelength range, as the light source that emits the white light, instead of a laser light source, which has a narrow wavelength range.

### Technique 4

The odor identification system according to Technique 1, wherein the light is laser light, and the detector detects a reflection angle of the light transmitted through the polymer thin film, reflected by the fine uneven structure of the substrate, and exiting the polymer thin film.

According to Technique 4, the characteristics of the polymer thin film change as an odor molecule included in the sample gas becomes adsorbed onto the polymer thin film, and the reflection angle of the light reflected by the fine uneven structure changes. This configuration makes it possible to identify the odor of the sample gas with ease based on the change in the reflection angle of the light detected by the detector.

### Technique 5

The odor identification system according to any one of Techniques 1 to 4, wherein the polymer thin film includes at least one selected from the group consisting of polyalkylene glycols, polyesters, silicones, glycerols, nitriles, dicarboxylic acid monoesters, and aliphatic amines.

According to Technique 5, an odor molecule included in the sample gas can be reversibly adsorbed onto and desorbed from the polymer thin film.

### Technique 6

The odor identification system according to any one of Techniques 1 to 5, including a plurality of polymer thin films of different kinds, each of the plurality of polymer thin films being the polymer thin film, wherein the plurality of polymer thin films are disposed in an array on the principal surface of the substrate.

According to Technique 6, the odor of the sample gas can be identified with higher accuracy.

### Technique 7

The odor identification system according to any one of Techniques 1 to 6, wherein the fine uneven structure is a diffraction grating.

According to Technique 7, the structural color can be exhibited effectively by the diffraction grating.

### Technique 8

A gas sensor to be used in an odor identification system that identifies an odor of a sample gas, the gas sensor including a substrate including a principal surface in which a fine uneven structure is formed to exhibit a structural color; and a polymer thin film disposed to cover the principal surface of the substrate, the polymer thin film having a light transmissive property and being capable of adsorbing an odor molecule included in the sample gas.

According to Technique 8, the gas sensor can be constructed by disposing the polymer thin film on the principal surface of the substrate in which the fine uneven structure is formed. This configuration renders the prism couplers described in the section titled Background Art above unnecessary and makes it possible to produce a smaller and more highly integrated gas sensor.

It is to be noted that general or specific aspects of the above may be implemented in the form of a system, a method, an integrated circuit, a computer program, or a non-transitory computer readable recording medium, such as a CD-ROM, or through any desired combinations of a system, a method, an integrated circuit, a computer program, and a recording medium.

Hereinafter, some embodiments will be described in concrete terms with reference to the drawings.

The embodiments described below merely illustrate general or specific examples. The numerical values, the shapes, the materials, the constituent elements, the arrangement positions and the connection modes of the constituent elements, the steps, the order of the steps, and so on illustrated according to the following embodiments are examples and are not intended to limit the present disclosure. Of the constituent elements according to the following embodiments, any constituent elements that are not included in the independent claims expressing the broadest concept are to be construed as optional constituent elements.

### Embodiment 1

### 1. Configuration of Odor Identification System

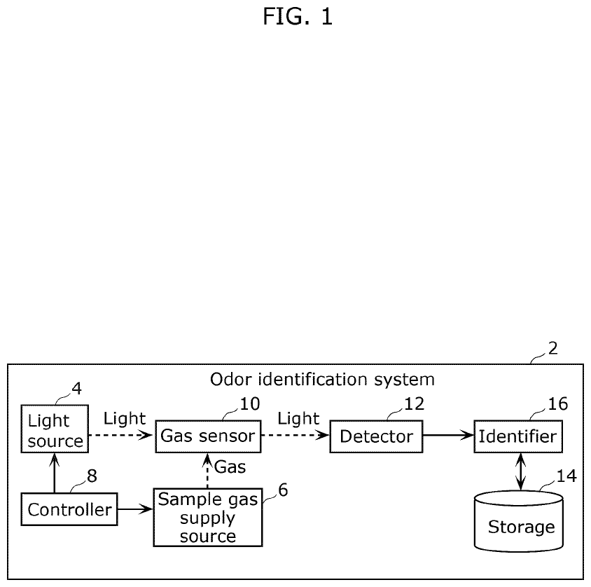

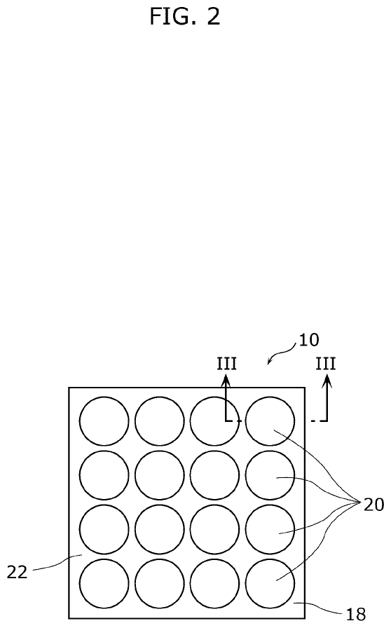

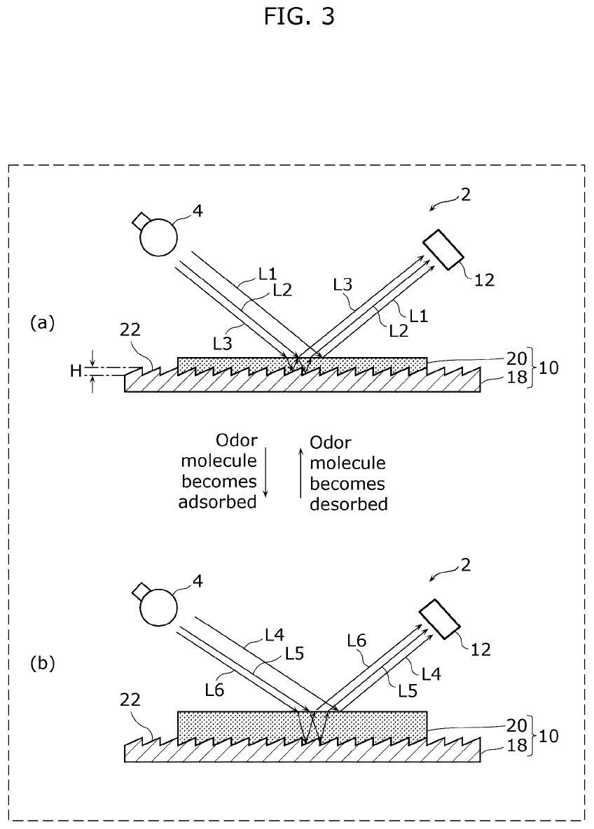

A configuration of odor identification system 2 according to Embodiment 1 will be described with reference to FIG. 1 to FIG. 3. FIG. 1 is a block diagram showing a configuration of odor identification system 2 according to Embodiment 1. FIG. 2 is a plan view showing gas sensor 10 of odor identification system 2 according to Embodiment 1. FIG. 3 is a schematic sectional view of gas sensor 10 of odor identification system 2 according to Embodiment 1, taken along the III-III line indicated in FIG. 2.

Odor identification system 2 is a system that identifies the odor of a sample gas. In other words, odor identification system 2 determines whether a sample gas includes any one of a plurality of kinds of odor molecules. For example, a sample gas is a gas (a gaseous body) collected from a food item, and odor identification system 2 is used as a system that performs a total inspection to determine whether a foul-smelling gas is occurring from food items successively conveyed by a conveyer in a food production line.

As shown in FIG. 1, odor identification system 2 includes light source 4, sample gas supply source 6, controller 8, gas sensor 10, detector 12, storage 14, and identifier 16.

Light source 4 is a light source that emits white light toward gas sensor 10. Specifically, light source 4 includes a light emitting element constituted, for example, by a blue light emitting diode (LED) and a phosphor that is disposed so as to face the light emitting surface of the light emitting element and that emits yellow fluorescence. As the blue light from the blue LED and the yellow fluorescence from the phosphor are mixed together, white light is emitted from light source 4. The white light emitted from light source 4 is visible light in a wavelength range of, for example, from 400 nm to 900 nm. It is to be noted that, although the present embodiment employs the configuration of light source 4 in which a light emitting element and a phosphor are combined, this configuration is not a limiting example, and light source 4 may instead be constituted, for example, by a mercury lamp. Alternatively, with light source 4 omitted, the sunlight or light from an indoor light may be applied to gas sensor 10 as white light.

Sample gas supply source 6 supplies a sample gas into a container (not shown) housing gas sensor 10.

Controller 8 controls the on/off of light source 4. Controller 8 also controls the supply of a sample gas from sample gas supply source 6.

Gas sensor 10 is a sensor that detects a sample gas and is configured to be capable of exhibiting a structural color. Gas sensor 10 is housed in the container and exposed to a sample gas supplied into the container from sample gas supply source 6. At this point, an odor molecule included in the sample gas becomes adsorbed onto gas sensor 10, and thus the structural color of gas sensor 10 changes.

Now, a configuration of gas sensor 10 will be described more specifically. As shown in FIG. 2 and FIG. 3, gas sensor 10 includes substrate 18 and a plurality of polymer thin films 20.

Substrate 18 has a planar shape. Fine uneven structure 22 is formed in the principal surface of substrate 18 so as to exhibit a structural color. Fine uneven structure 22 is a diffraction grating (a grating), and height H (the difference between the height of the most protruding portion and the height of the most recessed portion) of fine uneven structure 22 is, for example, 0.1 μm. Substrate 18 can be constituted, for example, by an optical disc, such as a compact disc (CD), a digital versatile disc (DVD), or a Blu-ray (registered trademark) disc (BD). In such a case, fine uneven structure 22 is realized by the plurality of pits formed in the recording surface of the optical disc. For the sake of clarity, FIG. 3 shows the size of fine uneven structure 22 larger than its actual size.

The plurality of polymer thin films 20 are each formed, for example, in a circular shape as viewed in plan view and are disposed so as to cover the principal surface of substrate 18. Herein, the plurality of polymer thin films 20 are disposed in an array over the principal surface of substrate 18. The plurality of polymer thin films 20 are each transparent and are each configured to be capable of reversibly adsorbing and desorbing an odor molecule included in a sample gas. In other words, the plurality of polymer thin films 20 each include a polymer having a high affinity with a sample gas. As the plurality of polymer thin films 20 each adsorb an odor molecule, the characteristics (e.g., the thickness, the refractive index, and so on) of each of the plurality of polymer thin films 20 change. Herein, the plurality of polymer thin films 20 do not necessarily have to have a transparency at an optical transmittance of 100%. The plurality of polymer thin films 20 may, for example, have a transparency at an optical transmittance of from 80% to 90%, or it suffices that the plurality of polymer thin films 20 at least have a light transmissive property.

The plurality of polymer thin films 20 are each formed of a different kind of polymer and each include, for example, at least one polymer material selected from the group consisting of polyalkylene glycols, polyesters, silicones, glycerols, nitriles, dicarboxylic acid monoesters, and aliphatic amines. The plurality of polymer thin films 20 each have a thickness greater than the wavelength (e.g., from 400 nm to 900 nm) of the light from light source 4. Herein, the plurality of polymer thin films 20 can be formed on the principal surface of substrate 18 by applying any of the polymer materials described above onto the principal surface of substrate 18, for example, with the use of a technique such as inkjet spotting, spin coating, polymer solution casting, melt extrusion, or vapor deposition.

As shown in (a) of FIG. 3, in a state in which no sample gas is supplied into the container, none of the plurality of polymer thin films 20 adsorbs an odor molecule. In this state, as indicated by arrow L1, a part of the white light from light source 4 is reflected by the surface of each of the plurality of polymer thin films 20 (that is, by the surface opposite to where substrate 18 is located). Meanwhile, as indicated by arrows L2 and L3, other parts of the white light from light source 4 are transmitted through each of the plurality of polymer thin films 20, are reflected by fine uneven structure 22 of substrate 18 to be separated into spectral components, and exit through the surface of each of the plurality of polymer thin films 20. At this point, the light reflected by the surface of each of the plurality of polymer thin films 20 interferes with the light reflected by fine uneven structure 22 of substrate 18 and separated into spectral components. Through this interference, light of a specific wavelength is intensified, and gas sensor 10 exhibits a structural color.

Meanwhile, as shown in (b) of FIG. 3, in a state in which a sample gas has been supplied into the container, the plurality of polymer thin films 20 each adsorb an odor molecule included in the sample gas. In this state, as indicated by arrow L4, a part of the white light from light source 4 is reflected by the surface of each of the plurality of polymer thin films 20. Meanwhile, as indicated by arrows L5 and L6, other parts of the white light from light source 4 are transmitted through each of the plurality of polymer thin films 20, are reflected by fine uneven structure 22 of substrate 18 to be separated into spectral components, and exit through the surface of each of the plurality of polymer thin films 20. At this point, the light reflected by the surface of each of the plurality of polymer thin films 20 interferes with the light reflected by fine uneven structure 22 of substrate 18 and separated into spectral components. Through this interference, light of a specific wavelength is intensified, and gas sensor 10 exhibits a structural color.

In response to an odor molecule becoming adsorbed onto each of the plurality of polymer thin films 20, the characteristics of each of the plurality of polymer thin films 20 change. For example, in response to an odor molecule becoming adsorbed onto each of the plurality of polymer thin films 20, the thickness of each of the plurality of polymer thin films 20 increases, and thus the refractive index of each of the plurality of polymer thin films 20 changes. With this change, the optical path, the angle of refraction, and so forth of the light transmitted through each of the plurality of polymer thin films 20 change, and thus the wavelength of the light intensified by the light interference changes. As a result, the structural color of gas sensor 10 exhibited in the state shown in (b) of FIG. 3 changes from the structural color of gas sensor 10 exhibited in the state shown in (a) of FIG. 3.

When the sample gas is discharged from the container in the state shown in (b) of FIG. 3, the odor molecule becomes desorbed from each of the plurality of polymer thin films 20. With this desorption, the state shown in (b) of FIG. 3 shifts to the state shown in (a) of FIG. 3. At this point, as the odor molecule becomes desorbed from each of the plurality of polymer thin films 20, the characteristics of each of the plurality of polymer thin films 20 change again, and the structural color of gas sensor 10 also changes again.

Herein, since the plurality of polymer thin films 20 each include a polymer having a high affinity with a sample gas, the plurality of polymer thin films 20 react with odor molecules rather quickly and adsorb a rather large number of odor molecules. This configuration can produce a quicker and larger change in the wavelength of the light. In other words, the reaction represented by the formula A +B AB becomes a reaction that follows a chemical reaction expressed by the Michaelis-Menten equation characterized by K=[A][B]/[AB], and thus it becomes possible to obtain a parameter (e.g., the reaction rate constant) related to the reaction rate as an output value. Furthermore, the desorption process of an odor molecule from each of the plurality of polymer thin films 20 observed when a sample gas is discharged from the container is also expressed by the Michaelis-Menten equation, and this makes it possible to obtain a parameter related to the desorption.

Detector 12 is constituted, for example, by an image sensor. Detector 12 receives light reflected by the surface of each of the plurality of polymer thin films 20. Detector 12 also receives light transmitted through each of the plurality of polymer thin films 20, reflected by fine uneven structure 22 of substrate 18, and exiting through the surface of each of the plurality of polymer thin films 20. Detector 12 converts the received light into an electrical signal and detects the wavelength of the received light (i.e., the structural color of gas sensor 10) in the form of RGB data. Detector 12 outputs the result of the detection to identifier 16.

Storage 14 is a memory that stores a trained model to be used by identifier 16. The trained model is a logical data model for identifying the odor of a sample gas. Specifically, the trained model is, for example, a logical data model for determining whether a sample gas includes any one of a plurality of types of odor molecules. The trained model, for example, accepts each feature value of the RGB data detected by detector 12 as an input and outputs information indicating whether the sample gas includes any one of a plurality of kinds of odor molecules.

The trained model is constructed, for example, through machine learning in which the training data are known odor molecules and the feature values of the RGB data obtained from detector 12 that has received the light reflected by gas sensor 10 exposed to the sample gas that includes the known odor molecules. For constructing the logical data model through machine learning, a neural network, a random forest, a support vector machine, or a self-organizing map, for example, is used.

Identifier 16 calculates a change in the feature values of the RGB data, detected by detector 12, between before and after an odor molecule becomes adsorbed onto gas sensor 10. Then, identifier 16 identifies the odor of the sample gas based on the calculated change in the feature values with the use of the trained model stored in storage 14. Specifically, identifier 16 determines whether the sample gas includes any one of a plurality of kinds of odor molecules with the use of the trained model. Identifier 16, for example, outputs information indicating the result of the determination to, for example but not limited to, a display (not shown) provided in odor identification system 2. With this configuration, the display displays the result of the determination made by identifier 16.

### 2. Operation of Odor Identification System

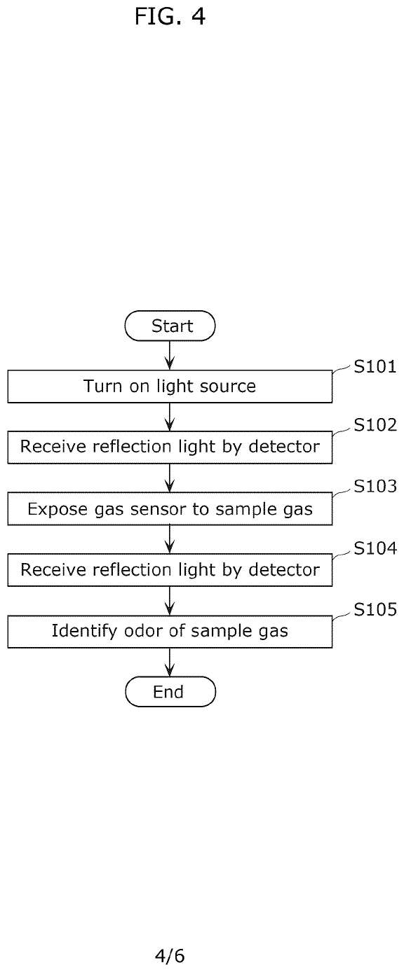

Next, an operation of odor identification system 2 according to Embodiment 1 will be described with reference to FIG. 4. FIG. 4 is a flowchart showing a flow of an operation of odor identification system 2 according to Embodiment 1.

As shown in FIG. 4, first, controller 8 turns on light source 4 (S101). Then, in a state in which no sample gas is being supplied from sample gas supply source 6 into the container, detector 12 receives light reflected by gas sensor 10 (S102) and detects the RGB data corresponding to the received light.

Next, controller 8 supplies a sample gas from sample gas supply source 6 into the container and exposes gas sensor 10 to the sample gas (S103). Next, detector 12 receives light reflected by gas sensor 10 (S104) and detects the RGB data corresponding to the received light.

Next, identifier 16 calculates a change between the feature values of the RGB data corresponding to the light received by detector 12 at step S102 and the feature values of the RGB data corresponding to the light received by detector 12 at step S104. Then, identifier 16 identifies the odor of the sample gas based on the calculated change in the feature values with the use of the trained model stored in storage 14 (S105). Thereafter, the processes shown in the flowchart of FIG. 4 are terminated.

### 3. Advantageous Effects

As described above, gas sensor 10 is constituted as the plurality of polymer thin films 20 are each disposed on the principal surface of substrate 18 in which fine uneven structure 22 is formed. This configuration renders the prism couplers described in the section titled Background Art above unnecessary and makes it possible to produce smaller and more highly integrated gas sensor 10. For example, with the use of an inkjet process, about one million polymer thin films 20 made of polymer can be formed within a width of 26 mm.

Furthermore, the present embodiment enables the use of, for example but not limited to, a mercury lamp, which is inexpensive and has a broad wavelength range, as light source 4, instead of a laser light source, which has a narrow wavelength range.

### 4. Experiment

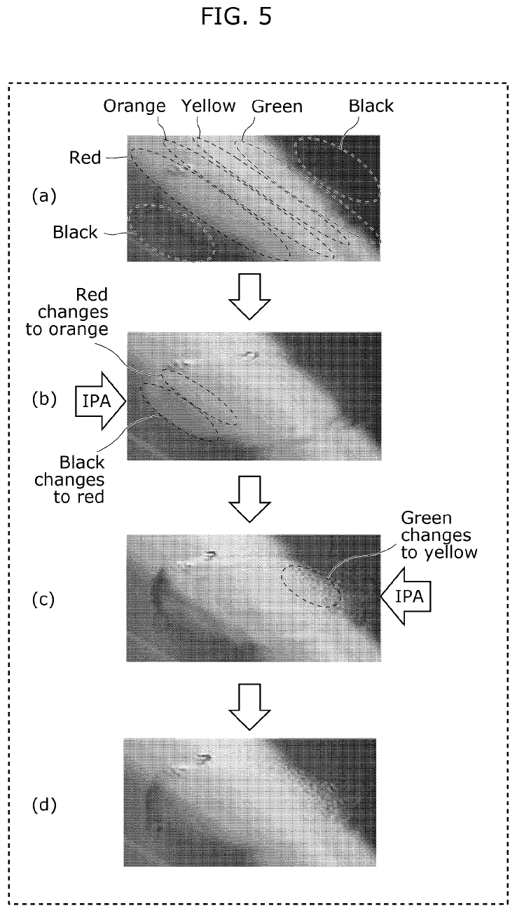

The experiment described below was conducted in order to confirm that the structural color of gas sensor 10 changed as gas sensor 10 was exposed to a sample gas. Hereinafter, this experiment will be described with reference to FIG. 5. FIG. 5 presents photographs showing a result of an experiment in which a gas sensor is exposed to isopropyl alcohol.

In this experiment, an optical disc (its light transmitting layer had a thickness of 0.1 mm, and the track pitch was 0.32 μm) was used as the substrate of the gas sensor. Furthermore, OV-330 (silicone carbowax copolymer) manufactured by Shinwa Chemical Industries Ltd. was used for the polymer thin films of the gas sensor, and OV-330 (silicone carbowax copolymer) was applied to the recording surface of the optical disc. As for the sample gas to which the gas sensor was exposed, volatized isopropyl alcohol (2-propanol) (indicated as “IPA” in FIG. 5) was used.

As shown in (a) of FIG. 5, in a state held before the gas sensor was exposed to isopropyl alcohol, the gas sensor exhibited structural colors of black, red, orange, yellow, green, and black in this order from the left-side region to the right-side region of the gas sensor.

Next, as shown in (b) of FIG. 5, isopropyl alcohol was directed toward the gas sensor from its left side for 30 seconds at a flow rate of 2 liters per minute, and thus the left-side region of the gas sensor was exposed to isopropyl alcohol. As a result, as shown in (b) of FIG. 5, of the structural colors of the left-side region of the gas sensor, a part of the black changed to red, and a part of the red changed to orange.

Then, as shown in (c) of FIG. 5, isopropyl alcohol was directed toward the gas sensor from its right side for 30 seconds at a flow rate of 2 liters per minute, and thus the right-side region of the gas sensor was exposed to isopropyl alcohol. As a result, as shown in (c) of FIG. 5, of the structural colors of the right-side region of the gas sensor, a part of the green changed to yellow.

Thereafter, in three minutes after isopropyl alcohol was stopped being directed toward the gas sensor, as shown in (d) of FIG. 5, the structural colors of the gas sensor that had changed as the gas sensor was exposed to isopropyl alcohol returned to their original structural colors (i.e., the structural colors of the gas sensor shown in (a) of FIG. 5).

Meanwhile, when the air, instead of isopropyl alcohol, was directed toward the gas sensor for 30 seconds at a flow rate of 2 liters per minute, the structural colors of the gas sensor underwent no change.

Based on the above, it was confirmed that the change in the structural colors of the gas sensor was due to a change in the light interference associated with a change in the film thickness of OV-330 resulting from isopropyl alcohol becoming adsorbed onto OV-330.

### Embodiment 2

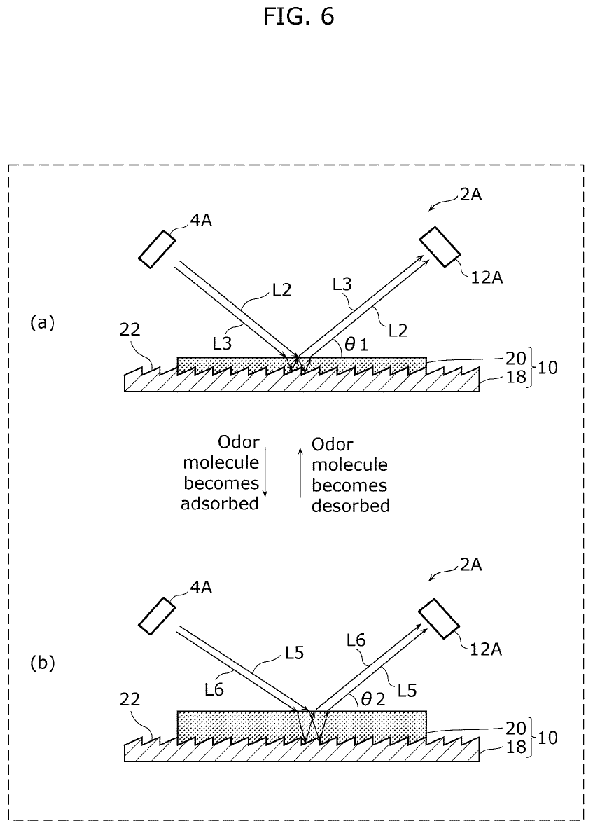

Next, odor identification system 2A according to Embodiment 2 will be described with reference to FIG. 6. FIG. 6 is a diagram showing a configuration of odor identification system 2A according to Embodiment 2. It is to be noted that, in the description of the present embodiment, constituent elements identical to those according to Embodiment 1 described above will be given identical reference characters, and description thereof will be omitted.

As shown in FIG. 6, odor identification system 2A according to Embodiment 2 is different from odor identification system 2 according to Embodiment 1 described above in the configuration of light source 4A and the configuration of detector 12A.

Light source 4A is a light source that emits laser light toward gas sensor 10 and is constituted, for example, by a laser diode.

Detector 12A receives laser light transmitted through each of the plurality of polymer thin films 20, reflected by fine uneven structure 22 of substrate 18, and exiting each of the plurality of polymer thin films 20, and thus detects the reflection angle of the received laser light. Detector 12A is constituted, for example, by a collimator.

As shown in (a) of FIG. 6, in a state in which no sample gas is being supplied into the container (not shown), none of the plurality of polymer thin films 20 adsorbs an odor molecule. In this state, as indicated by arrows L2 and L3, parts of the laser light from light source 4A are transmitted through each of the plurality of polymer thin films 20, are reflected by fine uneven structure 22 of substrate 18 at reflection angle θ1, and exit through the surface of each of the plurality of polymer thin films 20.

As shown in (b) of FIG. 6, in a state in which a sample gas has been supplied into the container, the plurality of polymer thin films 20 each adsorb an odor molecule included in the sample gas. In this state, as indicated by arrows L5 and L6, parts of the laser light from light source 4A are transmitted through each of the plurality of polymer thin films 20, are reflected by fine uneven structure 22 of substrate 18 at reflection angle θ2 (≠θ1), and exit through the surface of each of the plurality of polymer thin films 20.

In response to an odor molecule becoming adsorbed onto each of the plurality of polymer thin films 20, the characteristics of each of the plurality of polymer thin films 20 change. For example, in response to an odor molecule becoming adsorbed onto each of the plurality of polymer thin films 20, the thickness of each of the plurality of polymer thin films 20 increases, and thus the refractive index of each of the plurality of polymer thin films 20 changes. With this change, for example, the optical path and the angle of refraction of the laser light transmitted through each of the plurality of polymer thin films 20 change, and thus the reflection angle of the laser light changes from θ1 to θ2.

Then, the identifier (not shown) calculates a change in the feature values of the reflection angle of the laser light between before and after an odor molecule becomes adsorbed onto gas sensor 10 as detected by detector 12A. Then, the identifier identifies the odor of the sample gas based on the calculated change in the feature values with the use of the trained model stored in the storage (not shown).

Accordingly, the present embodiment can also provide advantageous effects similar to those provided by Embodiment 1 described above.

### Other Variations

Thus far, odor identification systems according to one or more aspects have been described based on the foregoing embodiments, but these embodiments do not limit the present disclosure. Unless departing from the spirit of the present disclosure, an embodiment obtained by making various modifications that a person skilled in the art can conceive of to any of the foregoing embodiments or an embodiment constructed by combining the constituent elements in different embodiments may also be encompassed by the scope of the one or more aspects.

For example, while a plurality of polymer thin films 20 are disposed on the principal surface of substrate 18 according to each of the foregoing embodiments, this is not a limiting example, and single polymer thin film 20 may be disposed on the principal surface of substrate 18.

Furthermore, for example, while fine uneven structure 22 is constituted by a diffraction grating according to each of the foregoing embodiments, this is not a limiting example, and any fine uneven structure other than a diffraction grating may be employed as long as such a fine uneven structure is configured to exhibit a structural color.

In each of the foregoing embodiments, the constituent elements may each be implemented by dedicated hardware or may each be implemented through execution of a software program suitable for the corresponding constituent element. Each of the constituent elements may be implemented as a program executing unit, such as a central processing unit (CPU) or a processor, reads out a software program recorded in a recording medium, such as a hard disk or a semiconductor memory, and executes the software program.

A part or the whole of the functions of the odor identification systems according to the foregoing embodiments may be implemented as a processor, such as a CPU, executes a program.

A part or the whole of the constituent elements constituting each of the devices described above may be implemented by an integrated circuit (IC) card that can be attached to or detached from the device or by a stand-alone module. Such an IC card or a module is a computer system constituted by a microprocessor, a read only memory (ROM), a random access memory (RAM), and so on. The IC card or the module may include an ultra-multifunctional large scale integration (LSI) circuit. The IC card or the module implements its functions as the microprocessor operates in accordance with a computer program. The IC card or the module may be tamper resistant.

### INDUSTRIAL APPLICABILITY

The odor identification system according to the present disclosure is useful as, for example but not limited to, a system for inspecting the presence of, for example, a foul odor in a food item in a food production line.

### REFERENCE SIGNS LIST

2, 2A odor identification system
4, 4A light source
6 sample gas supply source
8 controller
10 gas sensor
12, 12A detector
14 storage
16 identifier
18 substrate
20 polymer thin film
22 fine uneven structure

1. An odor identification system that identifies an odor of a sample gas, the odor identification system comprising:
a substrate including a principal surface in which a fine uneven structure is formed to exhibit a structural color;
a polymer thin film disposed to cover the principal surface of the substrate, the polymer thin film having a light transmissive property and being capable of adsorbing an odor molecule included in the sample gas; and
a detector that detects light transmitted through the polymer thin film, reflected by the fine uneven structure of the substrate, and exiting the polymer thin film.

2. The odor identification system according to claim 1, wherein
the light is white light, and
the detector detects the structural color exhibited as the light reflected by a surface of the polymer thin film interferes with the light transmitted through the polymer thin film, reflected by the fine uneven structure of the substrate, and exiting the polymer thin film.

3. The odor identification system according to claim 2, wherein
the white light has a wavelength range of from 400 nm to 900 nm.

4. The odor identification system according to claim 1, wherein
the light is laser light, and
the detector detects a reflection angle of the light transmitted through the polymer thin film, reflected by the fine uneven structure of the substrate, and exiting the polymer thin film.

5. The odor identification system according to claim 1, wherein
the polymer thin film includes at least one selected from the group consisting of polyalkylene glycols, polyesters, silicones, glycerols, nitriles, dicarboxylic acid monoesters, and aliphatic amines.

6. The odor identification system according to claim 1, comprising:
a plurality of polymer thin films of different kinds, each of the plurality of polymer thin films being the polymer thin film, wherein
the plurality of polymer thin films are disposed in an array on the principal surface of the substrate.

7. The odor identification system according to claim 1, wherein
the fine uneven structure is a diffraction grating.

8. A gas sensor to be used in an odor identification system that identifies an odor of a sample gas, the gas sensor comprising:
a substrate including a principal surface in which a fine uneven structure is formed to exhibit a structural color; and
a polymer thin film disposed to cover the principal surface of the substrate, the polymer thin film having a light transmissive property and being capable of adsorbing an odor molecule included in the sample gas.
